(19) United States
(12) Patent Application Publication
(10) Pub. No.: US 2021/0396846 A1
(43) Pub. Date: Dec. 23, 2021

(54) LIDAR SYSTEM WITH DETECTION SENSITIVITY OF PHOTODETECTORS

(71) Applicant: Continental Automotive Systems, Inc., Auburn Hills, MI (US)

(72) Inventors: Horst Wagner, Santa Barbara, CA (US); Min Ren, Santa Barbara, CA (US)

(73) Assignee: Continental Automotive Systems, Inc., Auburn Hills, MI (US)

(21) Appl. No.: 16/904,639

(22) Filed: Jun. 18, 2020

(51) Int. Cl. G01S 7/486; G01S 7/481; G01S 17/10; G01S 7/48; G01S 17/931

(52) U.S. Cl. CPC G01S 7/486; G01S 7/4816; G01S 17/10; G05D 1/0231; G01S 7/4808; G01S 17/931; G01S 7/4814

(57) ABSTRACT

A Lidar system includes a light emitter and a photodetector. The Lidar system includes a computer having a processor and a memory storing instructions executable by the processor to actuate the light emitter to output a series of shots. The instructions include instructions to provide a first bias voltage to the photodetector for a first period of time after the light emitter emits a first shot of a first subset of the series of shots. The instructions includes instructions to provide a second bias voltage to the photodetector for a second period of time after the light emitter emits a first shot of a second subset of the series of shots, the second bias voltage different than the first bias voltage, the second subset of shots emitted after the first subset of the series of shots.

### BACKGROUND

A Lidar system includes a photodetector, or an array of photodetectors. Light is emitted into a field of view of the photodetector. The photodetector detects light that is reflected by an object in the field of view. For example, a flash Lidar system emits pulses of light, e.g., laser light, into essentially the entire the field of view. The detection of reflected light is used to generate a 3D environmental map of the surrounding environment. The time of flight of the reflected photon detected by the photodetector is used to determine the distance of the object that reflected the light.

The Lidar system may be mounted on a vehicle to detect objects in the environment surrounding the vehicle and to detect distances of those objects for environmental mapping. The output of the Lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

Some applications, e.g., in a vehicle, include several Lidar systems. For example, the multiple system may be aimed in different directions and/or may detect light at different distance ranges, e.g., a short range and a long range.

### BRIEF DESCRIPTION OF THE DRAWINGS

FIG. 1 is a perspective view of a vehicle having a Lidar system.

FIG. 2 is a perspective view of the Lidar system.

FIG. 3 is a cross section of the Lidar system.

FIG. 4 is a perspective view of components of a light-receiving system of the Lidar system.

FIG. 4A is an enlarged illustration of a portion of FIG. 4.

FIG. 5 is a block diagram of components of the vehicle and the Lidar system.

FIG. 6 is an illustration of strength of an example optical return signal with respect to time of flight of emitted light and detection of the emitted light by a photodetector at various bias voltages.

FIG. 7 is a flow chart illustrating a process for controlling the Lidar system.

### DETAILED DESCRIPTION

With reference to the Figures, wherein like numerals indicate like parts, a Lidar system 20 is shown. The Lidar system 20 includes a light emitter 22 and one or more photodetectors 24, e.g., arranged in an array. The Lidar system 20 includes a computer 26 having a processor and a memory storing instructions executable by the processor to actuate the light emitter 22 to output a series of shots. The instructions include instructions to provide a first bias voltage to the photodetectors 24 for a first period of time after the light emitter 22 emits a first shot of a first subset of the series of shots. The instructions include instructions to provide a second bias voltage to at least some of the photodetectors 24 for a second period of time after the light emitter 22 emits a first shot of a second subset of the series of shots. The second bias voltage different, e.g., greater, than the first bias voltage, the second subset of shots emitted after the first subset of the series of shots.

Providing the photodetectors 24 with the various bias voltages enables the Lidar system to have different detection sensitivity for various detection distances without changing an intensity of the shots. In other words, the various bias voltages enable effective detection of relatively near and far objects, e.g., by having a higher gain for increased probability of detection of far objects and lower gain for increased resolution and/or accuracy when detecting near objects. Providing the photodetectors 24 with the various bias voltages also reduces negative impact of dead time in which the photodetectors 24 have inhibited detection abilities (such as during quenching a SPAD, as further described below), e.g., by operating at a bias voltage above breakdown voltage of the photodetector 24 for only some (not all) of the shots of the series of shots.

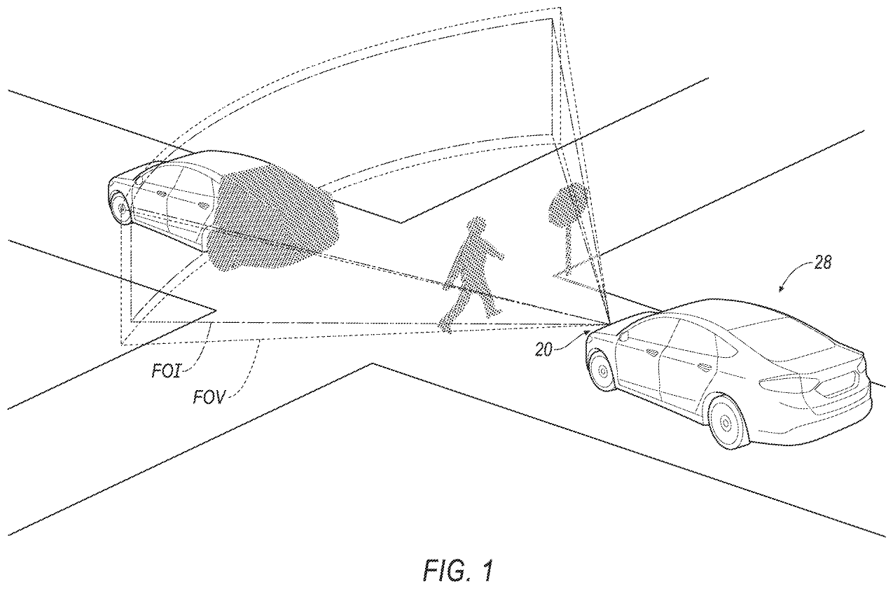

FIG. 1 shows an example vehicle 28. The Lidar system 20 is mounted to the vehicle 28. In such an example, the Lidar system 20 is operated to detect objects in the environment surrounding the vehicle 28 and to detect distances of those objects for environmental mapping. The output of the Lidar system 20 may be used, for example, to autonomously or semi-autonomously control the operation of the vehicle 28, e.g., propulsion, braking, steering, etc. Specifically, the Lidar system 20 may be a component of or in communication with an advanced driver-assistance system (ADAS) 30 of the vehicle 28. The Lidar system 20 may be mounted on the vehicle 28 in any suitable position and aimed in any suitable direction. As one example, the Lidar system 20 is shown on the front of the vehicle 28 and directed forward. The vehicle 28 may have more than one Lidar system 20 and/or the vehicle 28 may include other object detection systems, including other Lidar systems 20. The vehicle 28 is shown in FIG. 1 as including a single Lidar system 20 aimed in a forward direction merely as an example. The vehicle 28 shown in the Figures is a passenger automobile. As other examples, the vehicle 28 may be of any suitable manned or un-manned type including a plane, satellite, drone, watercraft, etc.

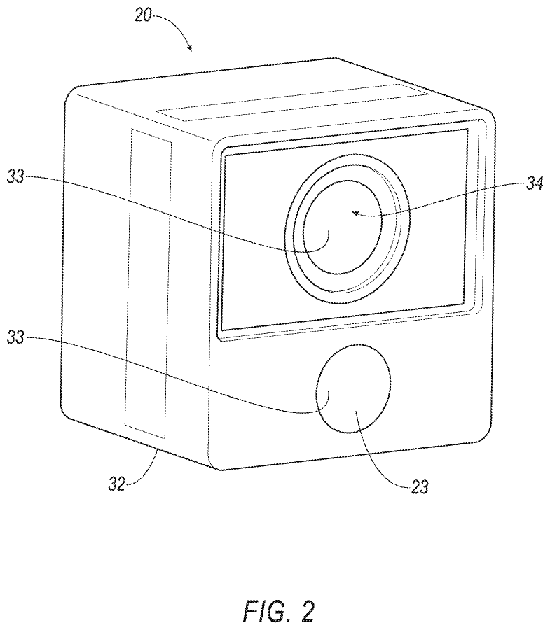

The Lidar system 20 may be a solid-state Lidar system 20. In such an example, the Lidar system 20 is stationary relative to the vehicle 28. For example, the Lidar system 20 may include a casing 32 (shown in FIG. 2 and described below) that is fixed relative to the vehicle 28, i.e., does not move relative to the component of the vehicle 28 to which the casing 32 is attached, and a silicon substrate of the Lidar system 20 is supported by the casing 32.

As a solid-state Lidar system, the Lidar system 20 may be a flash Lidar system. In such an example, the Lidar system 20 emits pulses of light into the field of illumination FOI. More specifically, the Lidar system 20 may be a 3D flash Lidar system 20 that generates a 3D environmental map of the surrounding environment, as shown in part in FIG. 1. An example of a compilation of the data into a 3D environmental map is shown in the FOV and the field of illumination (FOI) in FIG. 1. A 3D environmental map may include location coordinates of points within the FOV with respect to a coordinate system, e.g., a Cartesian coordinate system with an origin at a predetermined location such as a GPS (Global Positioning System) reference location, or a reference point within the vehicle 28, e.g., a point where a longitudinal axis and a lateral axis of the vehicle 28 intersect.

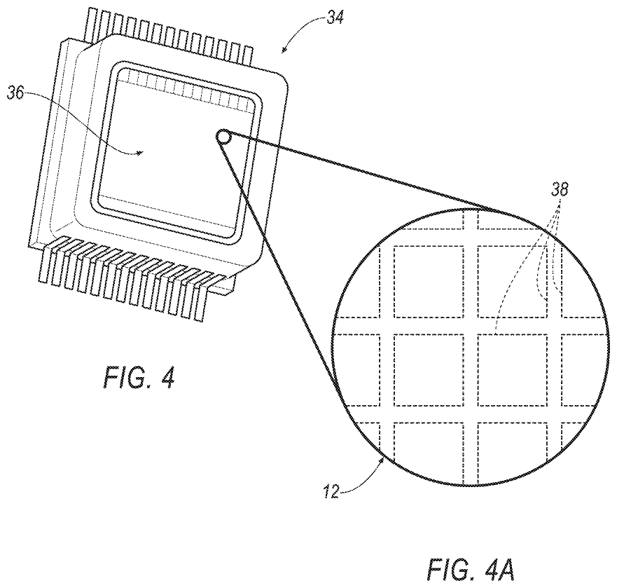

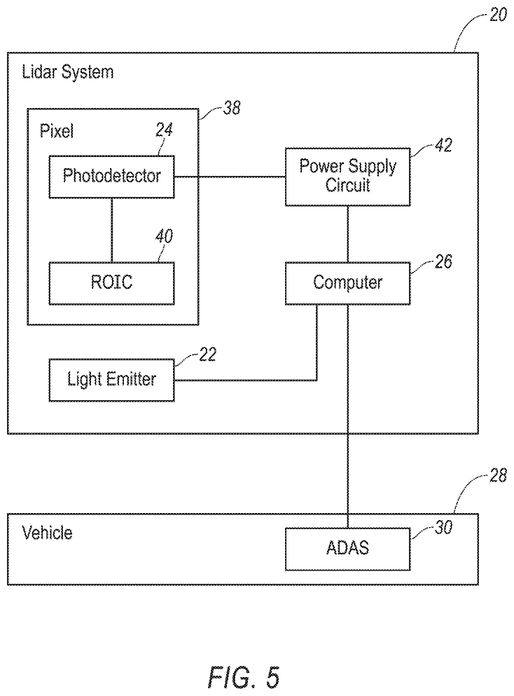

In such an example, the Lidar system 20 is a unit. A Lidar system 20 may include a casing 32, an outer optical facia 33, a light receiving system 34, and a light emitting system 23. The focal-plane array (FPA) 36 is a component of the light receiving system 34 of the Lidar system 20 as discussed below with respect to FIGS. 2-5.

The casing 32, for example, may be plastic or metal and may protect the other components of the Lidar system 20 from environmental precipitation, dust, etc. In the alternative to the Lidar system 20 being a unit, components of the Lidar system 20, e.g., the light emitting system 23 and the light receiving system 34, may be separate and disposed at different locations of the vehicle 28. The Lidar system 20 may include mechanical attachment features to attach the casing 32 to the vehicle 28 and may include electronic connections to connect to and communicate with electronic system of the vehicle 28, e.g., components of the ADAS.

The outer optical facia 33 (which may be referred to as a “window”) allows light to pass through, e.g., light generated by the light emitting system 23 exits the Lidar system 20 and/or light from environment enters the Lidar system 20. The outer optical facia 33 protects an interior of the Lidar system 20 from environmental conditions such as dust, dirt, water, etc. The outer optical facia 33 is typically formed of a transparent or semi-transparent material, e.g., glass, plastic. The outer optical facia 33 may extend from the casing 32 and/or may be attached to the casing 32.

The Lidar system 20 includes the light emitter 22 that emits shots, i.e., pulses, of light into the field of illumination FOI for detection by a light-receiving system 34 when the light is reflected by an object in the field of view FOV. The light-receiving system 34 has a field of view (hereinafter “FOV”) that overlaps the field of illumination FOI and receives light reflected by surfaces of objects, buildings, road, etc., in the FOV. The light emitter 22 may be in electrical communication with the computer 26, e.g., to provide the shots in response to commands from the computer 26.

The light emitting system 23 may include one or more light emitter 22 and optical components such as a lens package 41, lens crystal 42, pump delivery optics, etc. The optical components, e.g., lens package 41, lens crystal 42, etc., may be between the light emitter 22 on a back end of the casing 32 and the outer optical facia 33 on a front end of the casing 32. Thus, light emitted from the light emitter 22 passes through the optical components before exiting the casing 32 through the outer optical facia 33.

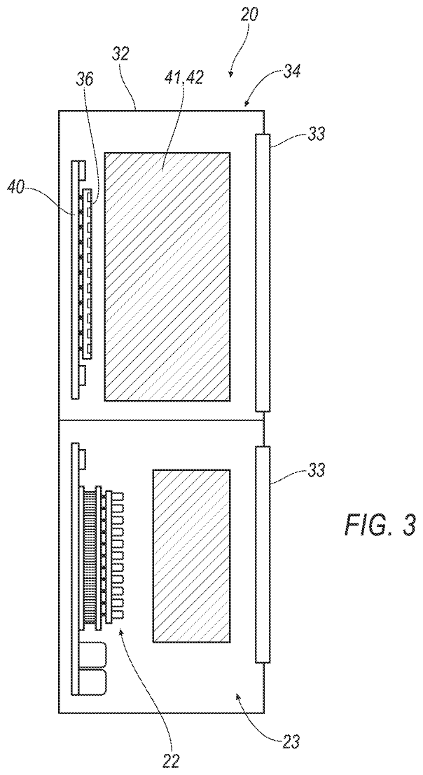

The light emitter 22 may be a semiconductor light emitter, e.g., laser diodes. In one example, as shown in FIG. 3, the light emitter 22 may include a vertical-cavity surface-emitting laser (VCSEL) emitter. As another example, the light emitter 22 may include a diode-pumped solid-state laser (DPSSL) emitter. As another example, the light emitter 22 may include an edge emitting laser emitter. The light emitter 22 may be designed to emit a pulsed flash of light, e.g., a pulsed laser light. Specifically, the light emitter 22, e.g., the VCSEL or DPSSL or edge emitter, is designed to emit a pulsed laser light. Each pulsed flash of light may be referred to as the “shot” as used herein. The light emitted by the light emitter 22 may be infrared light. Alternatively, the light emitted by the light emitter 22 may be of any suitable wavelength. The Lidar system 20 may include any suitable number of light emitters 22. In examples that include more than one light emitter 22, the light emitters 22 may be identical or different.

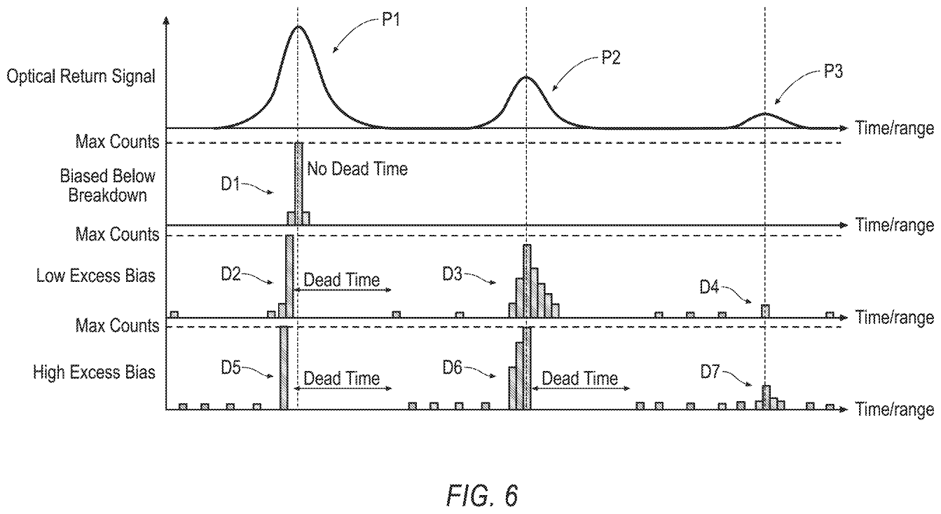

Light emitted by the light emitter 22 may be reflected off an object back to the Lidar system 20 and detected by the photodetectors 24. An optical signal strength of the returning light may be, at least in part, proportional to a time of flight/distance between the Lidar system 20 and the object reflecting the light. The optical signal strength may be, for example, an amount of photons that are reflected back to the Lidar system 20 from one of the shots of pulsed light. The greater the distance to the object reflecting the light/the greater the flight time of the light, the lower the strength of the optical return signal, e.g., for shots of pulsed light emitted at a common intensity. For example, and with reference to FIG. 6, a graph of the strength of the optical return signal with respect to the distance to the object reflecting the light/the flight time of the light is illustrated. In FIG. 6, increased height from a horizontal axis indicates increased optical signal strength, and increased distance to the right of a vertical axis indicates increased distance to the object reflecting the light/increased flight time of the light. For example, a peak P1 indicates light that is reflected off a relatively close object that returns with a relatively high optical signal strength. As another example, a peak P2 indicates light that is reflected off a relatively mid-range object that returns with a relatively mid-range optical signal strength. As another example, a peak P3 indicates light that is reflected off a relatively far object that returns with a relatively low optical signal strength. Apexes of the peaks P1, P2, P3 indicates a return time of the reflected light. The reflected light indicated by the peaks P1, P2, P3 may be from a single shot of pulsed of light emitted by the Lidar system 20 or from multiple shots of pulsed of light from the Lidar system 20.

The light-receiving system 34 detects light, e.g., emitted by the light emitter 22. The light-receiving system 34 may include a focal-plane array (FPA) 36. The FPA 36 can include an array of pixels 38. Each pixel 38 can include one of the photodetectors 24 and a read-out circuit (ROIC) 40. A power-supply circuit 42 may power the pixels 38. The FPA 36 may include a single power-supply circuit 42 in communication with all photodetectors 24 or may include a plurality of power-supply circuits 42 in communication with a group of the photodetectors 24. The light-receiving system 34 may include receiving optics such as the lens package. The light-receiving system 34 may include an outer optical facia and the receiving optics may be between the receiving outer optical facia and the FPA 36.

The FPA 36 detects photons by photo-excitation of electric carriers, e.g., with the photodetectors 24. An output from the FPA 36 indicates a detection of light and may be proportional to the amount of detected light. The outputs of FPA 36 are collected to generate a 3D environmental map, e.g., 3D location coordinates of objects and surfaces within FOV of the Lidar system 20. The FPA 36 may include the photodetectors 24, e.g., that include semiconductor components for detecting laser and/or infrared reflections from the FOV of the Lidar system 20. The photodetectors 24, may be, e.g., photodiodes (i.e., a semiconductor device having a p-n junction or a p-i-n junction) including avalanche photodetectors, metal-semiconductor-metal photodetectors, phototransistors, photoconductive detectors, phototubes, photomultipliers, etc. Optical elements such as a lens package of the light-receiving system 34 may be positioned between the FPA 36 in the back end of the casing 32 and the outer optical facia on the front end of the casing 32.

The ROIC 40 converts an electrical signal received from photodetectors 24 of the FPA 36 to digital signals. The ROIC 40 may include electrical components which can convert electrical voltage to digital data. The ROIC 40 may be connected to the computer 26, which receives the data from the ROIC 40 and may generate 3D environmental map based on the data received from the ROIC 40.

Each pixel 38 may include one photodetector 24, e.g., an avalanche-type photodetector (as described further below), connected to the power-supply circuits 42. Each power-supply circuit 42 may be connected to one of the ROICs 40. Said differently, each power-supply circuit 42 may be dedicated to one of the pixels 38 and each read-out circuit 40 may be dedicated to one of the pixels 38. Each pixel 38 may include more than one photodetector 24 (for example, two avalanche-type photodetectors).

The pixel 38 functions to output a single signal or stream of signals corresponding to a count of photons incident on the pixel 38 within one or more sampling periods. Each sampling period may be picoseconds, nanoseconds, microseconds, or milliseconds in duration. The pixel 38 can output a count of incident photons, a time between incident photons, a time of incident photons (e.g., relative to an illumination output time), or other relevant data, and the Lidar system 20 can transform these data into distances from the system to external surfaces in the fields of view of these pixels 38. By merging these distances with the position of pixels 38 at which these data originated and relative positions of these pixels 38 at a time that these data were collected, the computer 26 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

The pixels 38 may be arranged as an array, e.g., a 2-dimensional (2D) or a 1-dimensional (1D) arrangement of components. A 2D array of pixels 38 includes a plurality of pixels 38 arranged in columns and rows.

The photodetector 24 may be an avalanche-type photodetector. In other words, the photodetector 24 may be operable as an avalanche photodiode (APD) and a single-photon avalanche diode (SPAD) based on the bias voltage applied to the photodetector 24. When operated as an ADP, the photodetector 24 is an analog device that outputs an analog signal. To function as the ADP, the photodetector 24 may be biased at relatively high bias voltage that approaches, but is less than the breakdown voltage, of the semiconductor. Accordingly, the ADP is a linear amplifier for the input signal with limited gain, e.g., a current that is proportional to the light intensity incident on the ADP. To function as the SPAD, the photodetector 24 operates at a bias voltage above the breakdown voltage of the semiconductor, i.e., in Geiger mode. Accordingly, a single photon can trigger a self-sustaining avalanche with the leading edge of the avalanche indicating the arrival time of the detected photon. In other words, the SPAD is a triggering device.

The power-supply circuit 42 supplies power to the photodetector 24. The power-supply circuit 42 may include active electrical components such as MOSFET (Metal-Oxide-Semiconductor Field-Effect Transistor), BiCMOS (Bipolar CMOS), etc., and passive components such as resistors, capacitors, etc. The power-supply circuit 42 may include a power-supply control circuit. The power-supply control circuit may include electrical components such as a transistor, logical components, etc. The power-supply control circuit may control the power-supply circuit 42, e.g., in response to a command from the computer 26, to apply bias voltage (and quench and reset the photodetectors 24 in the event the photodetector 24 is operated as a SPAD).

Data output from the ROIC 40 may be stored in memory, e.g., for processing by the computer 26. The memory may be DRAM (Dynamic Random Access Memory), SRAM (Static Random Access Memory), and/or MRAM (Magneto-resistive Random Access Memory) electrically connected to the ROIC 40.

As set forth above, in examples in which the photodetector 24 operates as a SPAD, the SPAD operates in Geiger mode. “Geiger mode” means that the SPAD is operated above the breakdown voltage of the semiconductor and a single electron-hole pair (generated by absorption of one photon) can trigger a strong avalanche. The SPAD may be biased above its zero-frequency breakdown voltage to produce an average internal gain on the order of one million. Under such conditions, a readily-detectable avalanche current can be produced in response to a single input photon, thereby allowing the SPAD to be utilized to detect individual photons. “Avalanche breakdown” is a phenomenon that can occur in both insulating and semiconducting materials. It is a form of electric current multiplication that can allow very large currents within materials which are otherwise good insulators. It is a type of electron avalanche. In the present context, “gain” is a measure of an ability of a two-port circuit, e.g., the SPAD, to increase power or amplitude of a signal from the input to the output port.

When the SPAD is triggered in a Geiger-mode in response to a single input photon, the avalanche current continues as long as the bias voltage remains above the breakdown voltage of the SPAD. Thus, in order to detect the next photon, the avalanche current must be “quenched” and the SPAD must be reset. Quenching the avalanche current and resetting the SPAD involves a two-step process: (i) the bias voltage is reduced below the SPAD breakdown voltage to quench the avalanche current as rapidly as possible, and (ii) the SPAD bias is then raised by the power-supply circuit 42 to a voltage above the SPAD breakdown voltage so that the next photon can be detected.

Quenching is performed using, e.g., a quenching circuit or the like, e.g., using known techniques. Quenching is performed by sensing a leading edge of the avalanche current, generating a standard output pulse synchronous with the avalanche build-up, quenching the avalanche by lowering the bias down to the breakdown voltage and resetting the SPAD to the operative level.

Quenching may be passive or active quenching. A passive quenching circuit typically includes a single resistor in series with the SPAD. The avalanche current self-quenches because it develops a voltage drop across a resistor, e.g., 100 kΩ (Kilo Ohm) or more. After the quenching of the avalanche current, the SPAD bias voltage recovers and therefore will be ready to detect the next photon. An active circuit element can be used for resetting while performing a passive quench active reset (PQAR).

In an active quenching, upon measuring an onset of the avalanche current across a resistor, e.g., 50Ω, a digital output pulse, synchronous with the photon arrival time is generated. The quenching circuit then quickly reduces the bias voltage to below breakdown voltage, then returns bias voltage to above the breakdown voltage ready to sense the next photon. This mode is called active quench active reset (AQAR), however, depending on circuit requirements, active quenching passive reset (AQPR) may be provided. AQAR circuit typically allows lower dead times (times in which a photon cannot be detected) and reduces dead time compare to circuits having passive quenching and/or passive resetting.

The computer 26 of the Lidar system 20 is a microprocessor-based controller implemented via circuits, chips, or other electronic components. The computer 26 is in electronic communication with the pixels 38 (e.g., with the ROIC 40 and power-supply circuits 42) and the vehicle 28 (e.g., with the ADAS 30) to receive data and transmit commands. The computer 26 includes a processor and a memory. The computer 26 of the vehicle 28 may be programmed to execute operations disclosed herein. Specifically, the memory stores instructions executable by the processor to execute the operations disclosed herein and electronically stores data and/or databases. electronically storing data and/or databases. The memory includes one or more forms of computer-readable media, and stores instructions executable by the computer 26 for performing various operations, including as disclosed herein. For example, the computer 26 may include a dedicated electronic circuit including an ASIC (Application Specific Integrated Circuit) that is manufactured for a particular operation, e.g., calculating a histogram of data received from the Lidar system 20 and/or generating a 3D environmental map for a Field of View (FOV) of the vehicle 28. In another example, the computer 26 may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. The computer 26 may be a set of computers communicating with one another via the communication network of the vehicle 28, e.g., a computer in the Lidar system 20 and a second computer in another location in the vehicle 28.

The computer 26 may operate the vehicle 28 in an autonomous, a semi-autonomous mode, or a non-autonomous (or manual) mode. For purposes of this disclosure, an autonomous mode is defined as one in which each of vehicle propulsion, braking, and steering are controlled by the computer 26; in a semi-autonomous mode the computer 26 controls one or two of vehicle propulsion, braking, and steering; in a non-autonomous mode a human operator controls each of vehicle propulsion, braking, and steering.

The computer 26 may include programming to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 26, as opposed to a human operator, is to control such operations. Additionally, the computer 26 may be programmed to determine whether and when a human operator is to control such operations.

The computer 26 may include or be communicatively coupled to, e.g., via a vehicle 28 communication bus, more than one processor, e.g., controllers or the like included in the vehicle for monitoring and/or controlling various vehicle controllers, e.g., a powertrain controller, a brake controller, a steering controller, etc. The computer 26 is generally arranged for communications on a vehicle communication network that can include a bus in the vehicle such as a controller area network (CAN) or the like, and/or other wired and/or wireless mechanisms.

The computer 26 is programmed to instruct the light emitter 22 to emit a series of shots. The computer 26 operates the array of photodetectors 24 differently after the initiation of subsets of the series of shots. Specifically, the computer 26 adjusts the bias voltage to the array of photodetectors 24 just prior to, concurrently with the initiation of subsets of the series of shots. The computer 26 adjusts the bias voltage such that a photon returned from the subset of the series of shots is detected while that bias voltage is applied. For example, for a first bias voltage associated with a first subset of shots, the computer 26 applies the bias voltage at a suitable time to ensure that the array of photodetectors 24 is biased with the first bias voltage when a photon is returned from the first subset of shots. The initial application of that bias voltage is just prior to or concurrent with the initiation of subset of the series of shots and the application of the bias voltage continues during and after the emission of the subset of the series of shots.

The computer 26 is programmed to determine an amount of shots in the subsets of the series. For example, a series of shots may include a first subset of shots, a second subset of shots, and a third subset of shots. The second subset of shots of the series is after the first subset of the series of shots. The third subset of shots of the series is after the second subset of the series of shots. Each of the sub-sets may be associated with a detection range. For example, the first subset may be associated with relatively short-range detection of surfaces having a relatively low albedo and/or long range detection of detection of surfaces having a relatively high albedo, the second subset may be associated with relatively mid-range detection, and the third subset may be associated with relatively long-range detection. Each shot may by temporally spaced from the next by a specified amount of time. The amount of time may be predetermined and stored in memory, e.g., based on the sampling period of the photodetectors 24, the capabilities of the light emitter 22, etc. The computer 26 may be programmed to vary operation of the array of photodetectors 24 for any suitable number of subset of shots, i.e., two or more. The example described herein uses three subsets of shots, however, the computer 26 may operate on more than three subset of shots with each subset associated with a progressively longer range of intended detection. The number of shots of the first subset of the series of shots may be different, e.g., less, than the number of shots of the second subset of the series of shots. The number of shots of the second subset of the series of shots may be different, e.g., less, than the number of shots of the third subset of the series of shots. In other words, an amount of shots in each subset may progressively increase as the detection range associated with each subset increases. For example, the first subset may include 20 shots, the second subset may include 180 shots, and the third subset may include 800 shots. The increase in the amount of shots in the subsets enables greater probability of object detection and greater probability of accurate detection of movement of such objects, e.g., relatively farther objects may be less likely to reflect emitted light back to the Lidar system 20 and a certain amount of tangential linear movement at farther distances generally produces less angular movement relative the Lidar system 20 than the certain amount of tangential linear movement at closer distances.

As described below, the computer 26 may determine the amount of shots in each subset, and the associated operation of the array of photodetectors, based on a predetermined pattern and/or based on data received from the photodetectors 24 acquired from previous shots. Specifically, the computer 26 may determine the amount of shots in each subset by recalling data specifying the amount of shots from the memory. Such data may be prestored in the memory of the computer 26. The data may specify an amount of shots in each of the subsets of the series.

In addition to or in the alternative to determining the amount of shots by recalling prestored data from the memory of the computer, the computer 26 may determine the amount of shots of the series of shots based on data received from the photodetectors 24 indicating detection of prior shots, e.g., based on one or more signals from the ROIC 40. The computer 26 may store and use a look-up table, equation, or the like that associates detection of light from shots of a series of shots that were previous emitted by the light emitter 22 with various amounts of shots for the subsets. The computer 26 may determine an amount of the first shots, the second shots, and/or the third shots of the series by comparing an amount of shots of each subset that were previous emitted with an amount of shots of each subset that were subsequently detected. For example, the computer 26 may calculate a ratio of emitted shots to detected shots for each subset. The computer 26 may increase the amount of shots for the subset having the relatively highest ratio, and may decrease the amount of shots for the subset having the relatively lowest ratio. As another example, the series of shots may have a predefined amount of total shots, and the computer 26 may allocate such shots among the subset based on a distribution of the rations relative to each other. Other techniques may be used to determine the amount of shots of one or more of the subset, and/or other characteristics the series.

The computer 26 is programmed to actuate the light emitter 22 to output the series of shots. The computer 26 may actuate the light emitter 22 by transmitting a command to the light emitter 22 specifying such actuation. The command may specify a light intensity for the shots. Each shot of the series of shots may at the same light intensity level. The computer 26 may actuate the light emitter 22 to output the series of shots according to the determined characteristics of the series.

The computer 26 is programmed to determine bias voltages to provide to the photodetectors 24 of the array of photodetectors 24, e.g., a first bias voltage, a second bias voltage, a third bias voltage, etc., by recalling data specifying the bias voltages from memory. Such data may be prestored in memory of the computer 26. The data may specify bias voltages for association with each of the subsets of the series of shots. The bias voltage associated with each subset may progressively increase as the detection range associated with such subset increases. For example, the first bias voltage may be associated with the first subset, the second bias voltage may be associated with the second subset, and the third bias voltage may be associated with the third subset. In such example, the second bias voltage is greater than the first bias voltage, and the third bias voltage may be greater than the second bias voltage. Providing the relatively higher voltage increase the probability that the photodetector 24 will detect the emitted light reflected from relatively greater distances. Providing the relatively lower voltage reduces the need to quench and reset the avalanche photo detector, e.g., while the increase detection probability is no necessary required because of the relatively shorter distance to the object reflecting the emitted light.

At least one of the bias voltages may be less than the breakdown voltage for the avalanche photodetectors 24 and at least one of the bias voltages may be greater than the breakdown voltage for the avalanche photodetectors 24. For example, the first bias voltage may be less than the breakdown voltage for the avalanche photodetectors 24, e.g., 1 volt below the bias voltage. The bias voltage less than the breakdown voltage provides detection of emitted light with minimal background optical noise. In other words, the relatively low gain, if any, from having the bias voltage below the breakdown voltage does not significantly amplify the background optical noise. For example, the first bias voltage may provide detection of the light indicated at the peak P1, e.g., without increasing background noise.

Bars D1 in FIG. 6 indicate detection by a photodetector 24 provided with the first bias voltage of the reflected light indicated by the left most peak P1. The bars D1 correspond to the shape of the peak P1, i.e., with the tallest bar D1 aligning temporally with the apex of the peak P1. The photodetector 24 provided with the first bias voltage does not detect the light indicated by the center and right peaks P2, P3. According, providing the first bias voltage may be best suited for detection of relatively near-range objects.

The second bias voltage may be at or generally close to the breakdown voltage, e.g., less than or equal to 1 volt of excess voltage. In other words, the second bias voltage may be a relatively low excess bias voltage. The bias voltage at or generally close to the breakdown voltage increases the probability of detecting reflected light from the shots, e.g., by increasing gain, while concurrently reducing the need to quench and reset the photodetector 24. For example, the second bias voltage may provide increased sensitivity (e.g., compared to the first bias voltage) for detection of the light indicated at the peak P2 which is relatively less likely to be detected (e.g., compared to the light indicated at the peak P1).

Bars D2 in FIG. 6 indicate detection by a photodetector 24 provided with the second bias voltage of the reflected light indicated by the left most peak P1. The bars D2 do not correspond to the shape of the peak P1, e.g., indicating a highest bar D2 that is earlier than the apex of the peak P1. The intensity of the light of the peak P1 may be sufficient to trigger an avalanche in the photodetector 24 provided with the second bias voltage and the bars D2 may be followed by dead time in which the photodetector 24 is unable to detect light.

Bars D3 in FIG. 6 indicate detection by the photodetector 24 provided with the second bias voltage of the reflected light indicated by the center peak P2. The bars D3 correspond to the shape of the peak P2.

Bar D4 indicate detection by the photodetector 24 provided with the second bias voltage of the reflected light indicated by the left most peak P3. The bar D4 may not be of sufficient height/value to be distinguishable from background optical noise.

According, providing the second bias voltage may be best suited for detection of relatively mid-range objects.

The third bias voltage may be greater than the breakdown voltage, e.g., at least 2 volts greater than the breakdown voltage. In other words, the third bias voltage may operate the photodetector 24 in Geiger mode. The bias voltage greater than the breakdown voltage enables detection of objects at relative farther distances, e.g., that would unlikely be detected at the first bias voltage and the second bias voltage. For example, the third bias voltage may provide further increased sensitivity (e.g., compared to the second bias voltage) for detection of the light indicated at the peak P3 which is relatively less likely to be detected (e.g., compared to the light indicated at the peak P2).

Bar D5 in FIG. 6 indicates detection by a photodetector 24 provided with the third bias voltage of the reflected light indicated by the left most peak P1. The bars D5 do not correspond to the shape of the peak P1, e.g., indicating a highest bar D5 that is earlier than the apex of the peak P1. The intensity of the light of the peak P1 may be sufficient to trigger an avalanche in the photodetector 24 provided with the third bias voltage and the bar D5 may be followed by dead time in which the photodetector 24 is unable to detect light.

Bars D6 in FIG. 6 indicate detection by the photodetector 24 provided with the third bias voltage of the reflected light indicated by the center peak P2. The bars D6 do not correspond to the shape of the apex of the peak P2, e.g., indicating a highest bar D6 that is earlier than the apex of the peak P2. The intensity of the light of the peak P2 may be sufficient to trigger an avalanche in the photodetector 24 provided with the third bias voltage and the bars D6 may be followed by dead time in which the photodetector 24 is unable to detect light.

Bars D7 in FIG. 6 indicate detection by the photodetector 24 provided with the third bias voltage of the reflected light indicated by the right most peak P2. The bars D7 correspond to the shape of the apex of the peak P3.

According, providing the third bias voltage may be best suited for detection of relatively far-range objects and/or surfaces having a relatively low albedo.

The computer 26 may determine the bias voltages based on data received from the photodetectors 24 indicating detection of prior shots, e.g., based on one or more signals from the ROIC 40. Determining the bias voltages based on data received from the photodetectors 24 permits the bias voltage to be adaptively adjusted on a pixel 38 by pixel 38 basis. For example, the photodetectors 24 of some of the pixels 38 may be provided with the first, second, and/or third bias voltage, and the photodetectors 24 of other pixels 38 may be provided with a maximum bias voltage or a minimum bias voltage.

To determine the bias voltages, the computer 26 may identify that one or more of the photodetectors 24 that detect objects that are relatively close, and one or more other photodetectors 24 that detect objects that are relatively far. The computer 26 may select the minimum bias voltage when an object detected by one of the photodetectors 24 is less than a threshold distance. The computer 26 may select the maximum voltage when the detected object is farther than a threshold distance. The minimum bias voltage is less than the breakdown voltage, e.g., the same as the first bias voltage. The maximum bias voltage is greater than the breakdown voltage, e.g., the same as the third bias voltage. The maximum and minimum bias voltages may be predetermined and stored in memory.

The computer 26 is programmed to provide bias voltages to the photodetectors 24 of the array of photodetectors 24. The computer 26 may provide the bias voltages by sending a command to the power supply circuit, e.g., specifying the bias voltage. The computer 26 may provide the bias voltages according to the determined bias voltages.

The computer 26 is programmed to compile a histogram (e.g., that may be used to generate the 3D environmental map) based on detected shots of the series, e.g., detected by the photodetectors 24 and received from the ROICs 40. An example histogram is illustrated in FIG. 6. The histogram indicates an amount and/or frequency at which light is detected from different reflection distances, i.e., having different times of flights. The computer 26 may weigh the detected light represented in the histogram based on the bias voltage provided to the photodetector 24 detecting such light. For example, the computer 26 may increase bins of the histogram associated with a certain reflection distance by a value of one when the photodetector 24 is provided with a bias voltage that is above the breakdown voltage, e.g., the third bias voltage or the maximum bias voltage. The computer 26 may increase bins of the histogram associated with a certain reflection distance by a value of four when the photodetector 24 is provided with a bias voltage that is generally at the breakdown voltage (low excess bias voltage), e.g., the second bias voltage. The computer 26 may increase bins of the histogram associated with a certain reflection distance by a value of eight when the photodetector 24 is provided with a bias voltage that is below the breakdown voltage, e.g., the first bias voltage or the minimum bias voltage. As another example, the computer 26 may store a lookup table or the like associating various weights with various bias voltages. The computer 26 may compile the histogram based on the light detected with the photodetectors 24 and weighted as specified by the look up table and based on the bias voltage provided to the photodetectors 24. When increasing the counts of the various bins, the computer weights such increase based on the bias voltage at the time of detection. For example, one of the bins may be increased by a value of eight when the bias voltage is below the breakdown voltage upon light detection, and may increase such bin by a value of four when the bias voltage that is generally at the breakdown voltage.

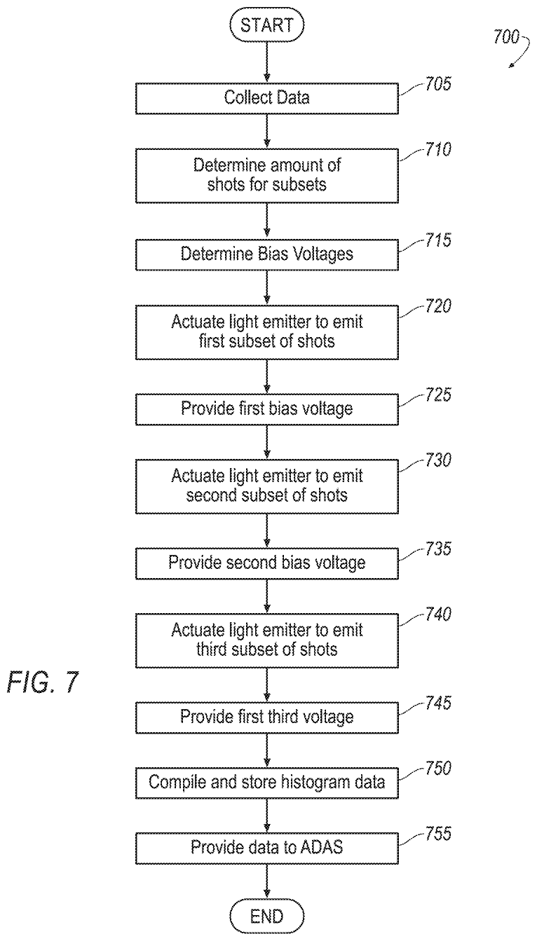

FIG. 7 is a process flow diagram illustrating an exemplary process 700 for controlling the Lidar system 20. The process 700 begins in a block 705. At the block 705 the computer 26 receives data, e.g., from the photodetectors 24 via the ROICs 40. The computer 26 may store the received data, e.g., in memory. The computer 26 may receive data substantially continuously and throughout the process 700.

At a block 710 the computer 26 determines an amount of shots for subsets of a series of shots, e.g., an amount of shots for a first subsets of shot of the series, an amount of shots for a second subset of shots of the series, and/or an amount of shots for a third subset of shots of the series. The computer 26 may determine the amount of shots for the subsets of the series be recalling data specifying the amount of shots from memory. The computer 26 may determine the amount of shots for the subsets based on data received from the photodetectors 24, e.g., from previously detected shots and as described herein.

At a block 715 the computer 26 determines bias voltages for the photodetectors 24. The computer 26 may recall a prestored first bias voltage, second bias voltage, and third bias voltage, e.g., as described herein. Additionally, the computer 26 may determine specific photodetectors 24 to provide a maximum bias voltage and/or specific photodetectors 24 to provide a minimum bias voltage, e.g., based on data received from the photodetectors 24 indicating previously detected shots and as described herein.

At a block 720 the computer 26 actuates the light emitter 22 to provide the first subset of shots of the series of shots. The computer 26 may actuate the light emitter 22 by sending one or more commands to the light emitter 22. The command(s) may specify the amount of shots of the first subset determined at the block 710.

At a block 725 the computer 26 provides the bias voltages to one or more of the photodetectors 24, e.g., by sending a command to the power supply circuits of the respective photodetectors 24. The computer 26 may provide the first bias voltage and may also provide the maximum bias voltage, e.g., as determined at the block 715 and as described herein. The maximum bias voltage may be different that the first bias voltage. The computer 26 may provide the maximum bias voltage to some of the photodetectors 24, and may provide the first bias voltage to other photodetectors 24.

The computer 26 may provide the first bias voltage to the photodetectors 24 for a first period of time after the light emitter 22 emits the first shot of the first subset of the series of shots such that light detected by the photodetectors 24 during the first period of time is from the light emitter 22 emitting the first subset of shots. The first period of time may begin just before or concurrently with a first shot of the first set of shots is emitted and lapse after a last shot of the first set of shots is emitted. The first period of time may be predetermined, e.g., based on an expected time of flight of the shots of the first subset, and stored in memory. The computer 26 may determine the first period of time based on the number of shots in the first subset. For example, the computer 26 may store and use a lookup table of the like associating various numbers of shows and timer intervals between shots with periods of times. As another example, the computer 26 may multiply the number of shots by the sampling period and/or specified amount of time between shots.

At a block 730 the computer 26 actuates the light emitter 22 to provide the second subset of shots of the series of shots. The computer 26 may actuate the light emitter 22 by sending one or more commands to the light emitter 22. The command(s) may specify the amount of shots of the second subset determined at the block 710.

At a block 735 the computer 26 provides the bias voltages to one or more of the photodetectors 24, e.g., by sending a command to the power supply circuits of the respective photodetectors 24. The computer 26 may provide the second bias voltage and may also provide the maximum bias voltage and/or the minimum bias voltage, e.g., as determined at the block 715 and as described herein. The maximum and minimum bias voltages may be different that the second bias voltage. The computer 26 may provide the maximum bias voltage to some of the photodetectors 24, the minimum bias voltage to other of the photodetectors 24, and may provide the second bias voltage to yet other photodetectors 24.

The computer 26 may provide a second bias voltage to the photodetectors 24 for a second period of time after the light emitter 22 emits the first shot of a second subset of the series of shots such that light detected by the photodetectors 24 during the second period of time is from the light emitter 22 emitting the second subset of shots. The second period of time may begin just before or concurrently with a first shot of the second set of shots is emitted and lapse after a last shot of the second set of shots is emitted. The second period of time may be predetermined, e.g., based on an expected time of flight of the shots of the second subset, and stored in memory. The computer 26 may determine the second period of time based on the number of shots in the second subset.

At a block 740 the computer 26 actuates the light emitter 22 to provide the third subset of shots of the series of shots. The computer 26 may actuate the light emitter 22 by sending one or more commands to the light emitter 22. The command(s) may specify the amount of shots of the third subset determined at the block 710.

At a block 745 the computer 26 provides the bias voltages to one or more of the photodetectors 24, e.g., by sending a command to the power supply circuits of the respective photodetectors 24. The computer 26 may provide the third bias voltage and may also provide the minimum bias voltage, e.g., as determined at the block 715 and as described herein. The minimum bias voltage may be different that the third bias voltage. The computer 26 may provide the minimum bias voltage to some of the photodetectors 24 and may provide the third bias voltage to other photodetectors 24.

The computer 26 may provide a third bias voltage to the photodetectors 24 for a third period of time after the light emitter 22 emits a first shot of a third subset of the series of shots such that light detected by the photodetectors 24 during the third period of time may be from the light emitter 22 emitting the third subset of shots. The third period of time may just before or concurrently with a first short of the third set of shots is emitted and lapse after a last shot of the third set of shots is emitted. The third period of time may be predetermined, e.g., based on an expected time of flight of the shots of the third subset, and stored in memory. The computer 26 may determine the third period of time based on the number of shots in the third sub set.

At a block 750 the computer 26 compiles a histogram based on shots of the series detected by the photodetectors. The computer 26 may weight values of the detected shot in the histogram based on the bias voltages, e.g., as described herein.

At a block 755 the computer provides data to the ADAS 30, e.g., data specifying a 3D environmental map that is based on the detected shots and/or the histogram. After the block 755 the process 700 may end. Alternately, the computer 24 may return the block 705 and iteratively perform the process 700.

With regard to the process 700 described herein, it should be understood that, although the steps of such process have been described as occurring according to a certain ordered sequence, such process could be practiced with the described steps performed in an order other than the order described herein. It further should be understood that certain steps could be performed simultaneously, that other steps could be added, or that certain steps described herein could be omitted. In other words, the description of the process herein is provided for the purpose of illustrating certain embodiments and should in no way be construed so as to limit the disclosed subject matter.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A Lidar system, comprising:
a light emitter;
a photodetector; and
a computer having a processor and a memory storing instructions executable by the processor to:
actuate the light emitter to output a series of shots;
provide a first bias voltage to the photodetector for a first period of time after the light emitter emits a first shot of a first subset of the series of shots; and
provide a second bias voltage to the photodetector for a second period of time after the light emitter emits a first shot of a second subset of the series of shots, the second bias voltage different than the first bias voltage, the second subset of shots emitted after the first subset of the series of shots.

2. The Lidar system of claim 1, wherein the number of shots of the first subset of the series of shots is different than the number of shots of the second subset of the series of shots.

3. The Lidar system of claim 1, wherein the photodetector is an avalanche-type photodetector.

4. The Lidar system of claim 3, wherein the first bias voltage is less than a breakdown voltage of the avalanche-type photodetector and the second bias voltage is greater than the breakdown voltage.

5. The Lidar system of claim 3, wherein the instructions include instructions to provide a third bias voltage to the photodetector for a third period of time after the light emitter emits a first shot of a third subset of the series of shots, the third bias voltage greater than the second bias voltage, the third subset of shots emitted after the second subset of the series of shots.

6. The Lidar system of claim 5, wherein the number of shots of the first subset of the series of shots is less than the number of shots of the second subset of the series of shots, and the number of shots of the second subset of the series of shots is less than the number of shots of the third subset of the series of shots.

7. The Lidar system of claim 6, wherein the first bias voltage is less than a breakdown voltage of the avalanche-type photodetector and the second bias voltage is greater than the breakdown voltage.

8. The Lidar system of claim 3, wherein the instructions include instructions to determine an amount of the second shots based on data received from the avalanche-type photodetector indicating detection of prior shots.

9. The Lidar system of claim 1, wherein each shot of the series of shots is at the same light intensity level.

10. The Lidar system of claim 1, wherein the instructions include instructions to provide a bias voltage different than the second bias voltage to the photodetector during the second period of time after the light emitter emits the first shot of the second subset of the series of shots.

11. The Lidar system of claim 1, wherein the instructions include instructions to weight values of detected light based on the first bias voltage and the second bias voltage.

12. The Lidar system of claim 11, wherein the instructions include instructions to compile a histogram based on the weighted values.

13. A method, comprising:
actuating a light emitter to output a series of shots;
providing a first bias voltage to a photodetector for a first period of time after the light emitter emits a first shot of a first subset of the series of shots; and
providing a second bias voltage to the photodetector for a second period of time after the light emitter emits a first shot of a second subset of the series of shots, the second bias voltage different than the first bias voltage, the second subset of shots emitted after the first subset of the series of shots.

14. The method of claim 13, wherein the number of shots of the first subset of the series of shots is different than the number of shots of the second subset of the series of shots.

15. The method of claim 13, wherein one of the bias voltages is less than a breakdown voltage for avalanche-type photodetectors of the photodetectors and another one of the bias voltages is greater than the breakdown voltage.

16. The method of claim 15, further comprising providing a third bias voltage to the at least some of the photodetectors for a third period of time after the light emitter emits a first shot of a third subset of the series of shots, the third bias voltage different than the second bias voltage, the third subset of shots emitted after the second subset of the series of shots.

17. The method of claim 16, wherein the number of shots of the first subset of the series of shots is less than the number of shots of the second subset of the series of shots, and the number of shots of the second subset of the series of shots is less than the number of shots of the third subset of the series of shots.

18. The method of claim 13, wherein the instructions include instructions to determine an amount of the second shots based on data received from the photodetectors indicating detection of prior shots.

19. The method of claim 13, wherein the instructions include instructions to provide the first bias voltage and the second bias voltage to one of the photodetectors and to provide a third bias voltage different than the second bias voltage to another of the photodetectors during the second period of time after the light emitter emits the second subset of the series of shots.

20. The method of claim 13, wherein the instructions include instruction to weight values of detected light based on the first bias voltage and the second bias voltage, and to compile a histogram based on the weighted values.
